(19) United States
(12) Patent Application Publication
(10) Pub. No.: US 2016/0112748 A1
(43) Pub. Date: Apr. 21, 2016

(54) MULTIFUNCTIONAL TELEVISION REMOTE CONTROL WITH ACCESS CONTROL AND METHOD

(71) Applicant: UMM AL-QURA UNIVERSITY, Makkah (SA)

(72) Inventor: RAFAT MADANI, MAKKAH (SA)

(21) Appl. No.: 14/520,166

(22) Filed: Oct. 21, 2014

(51) Int. Cl. H04N 21/422; H04N 21/45; H04N 21/488; H04N 21/4415

(52) U.S. Cl. CPC H04N 21/42225; H04N 21/42201; H04N 21/42222; H04N 21/4415; H04N 21/45; H04N 21/4882

(57) ABSTRACT

The multifunctional television remote control includes a fingerprint verification module and sensory feedback to monitor and control access to television content. The method includes placing at least one finger on a fingerprint reader, obtaining fingerprint data, verifying the user is an authorized user and providing feedback to the user, such as a child. The multifunctional remote control has a number of sensory feedbacks to provide children with information with respect to their choices regarding the television programs selected for viewing. The remote control's feedback capabilities include lighting representing the different feedback responses providing an interactive experience.

### BACKGROUND OF THE INVENTION

1. Field of the Invention

The present invention relates generally to remote control devices, and more particularly, to a multifunctional television remote control including sensory feedback and fingerprint verification to monitor and control user access to television programming.

2. Description of the Related Art

Security features for controlling access to television content have been developed to protect children from age-specific and/or inappropriate television content and programming. Recent studies have shown that television programming can impact a child's attitude, behavior, beliefs and knowledge. Further, other studies have shown that excessive television can negatively affect a child's socialization with his or her peers, world view, as well as general behavior. Additional harmful effects of excessive and/or inappropriate television content on children can include diminished learning development, increased aggression, as well as childhood obesity.

In the United States, devices such as the V-chip, are used to protect users, and particularly children, from unsuitable viewing content. In the United Kingdom, unsuitable programming for children can be blocked by devices, such as television receivers. While the aforementioned devices use password protection to control television programming access, they do not provide a personalized management system that can be pre-programmed by an administrator, such as a parent. Additionally, these devices are not user-specific and/or capable of detecting and controlling television programming access based on the user in possession of the remote control, which is typically how channel selection occurs. Thus, a multifunctional television remote control including finger-print recognition and sensory feedback to solve the aforementioned problems is desired.

### SUMMARY OF THE INVENTION

The multifunctional television remote control device includes a housing for handling by a user. The housing includes a first section, a third section and a second section intermediate to the first section and third section. The housing also includes an authentication device to detect at least one user biometric feature and obtain user biometric data. The authentication device is coupled to the housing. The multifunctional remote control device further includes a memory to store user feature information for at least one user. The memory is in operative communication with the authentication device and stores user feature information having pre-assigned viewing content for each user;

In addition, the multifunctional remote control includes a processor to compare user feature information stored in the memory, to the detected user biometric data, and permit preselected viewing content to be stored to memory. The processor is in operative communication with the authentication device and memory. The processor compares the detected biometric feature to user feature information stored in the memory and upon finding a match, permits the user to control selection of viewing content pre-assigned to the user.

The multifunctional remote control includes components to provide sensory feedback to children and other users. The multifunctional remote control has voice and visual feedback to enable children to make correct choices, especially regarding the television programs children choose to view, and warns children against making bad choices. The multifunctional remote control also includes feedback to the user via light panels displaying a number of colors representing different feedback responses.

The method for controlling television access using the multifunctional remote control comprises the steps of executing, with a processor, a program stored in a non-transitory memory of a computer implemented device and requiring a user to place a finger on the fingerprint recognition module of the multifunctional remote control for scanning. Thereafter, the method includes the steps of comparing the fingerprint data of the finger scanned to a record data, and when it is determined the action is authorized according to the record data, providing at least one sensory feedback, and sending a signal to allow access to the action.

These and other features of the present invention will become readily apparent upon further review of the following specification and drawings.

### BRIEF DESCRIPTION OF THE DRAWINGS

FIG. 1A is a perspective view of the multifunctional remote control including fingerprint verification and sensory feedback, according to the present invention.

FIG. 1B is a sectional view of a multifunctional remote control of FIG. 1A further illustrating features to provide fingerprint verification and sensory feedback, according to the present invention

FIG. 2 is a block diagram of the multifunctional remote control according to the present invention.

FIG. 3A is a flow chart illustrating steps for operating the multifunctional remote control, according to the present invention.

FIG. 3B is a flow chart continuing from FIG. 3A, further illustrating steps for operating the multifunctional remote control, according to the present invention.

Similar reference characters denote corresponding features consistently throughout the attached drawings.

### DETAILED DESCRIPTION OF THE PREFERRED EMBODIMENTS

The multifunctional television remote control, generally referred to by reference number 100 in the drawings, includes fingerprint verification and sensory feedback, to monitor and control user viewing of various programs. These include, but are not limited thereto, television programs, multimedia videos, presentation slides, and the like which can be construed as viewing content in general. Various embodiments shown are provided for illustrative purposes, and accordingly should not be construed in a limiting sense or limited to the illustrations provided.

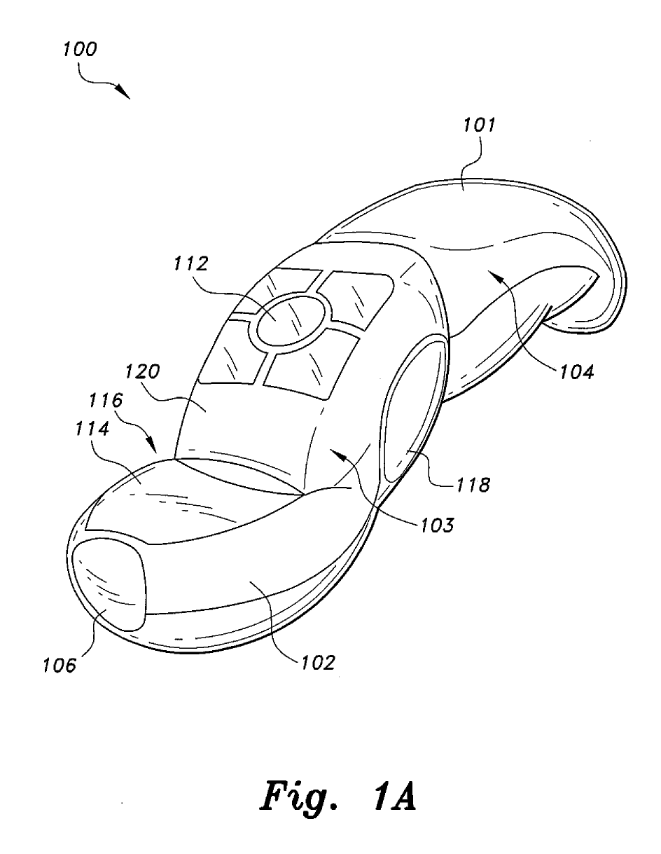

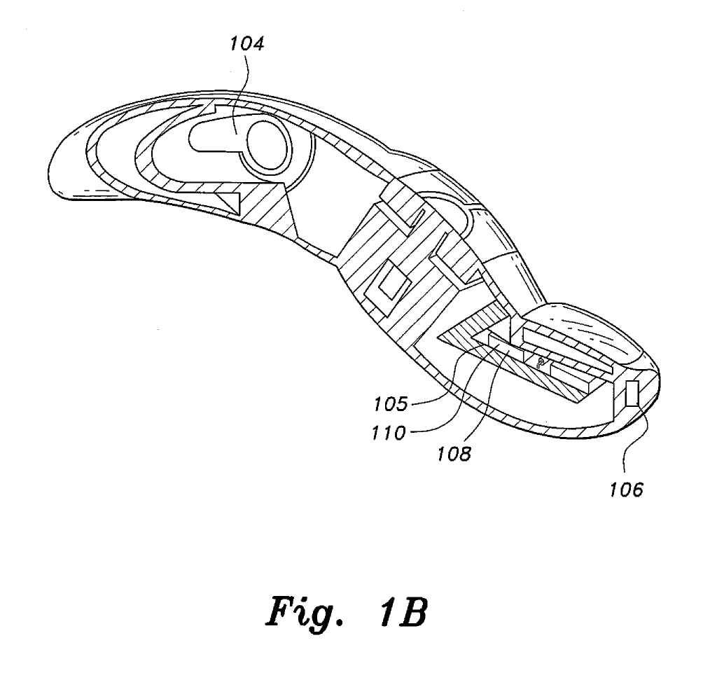

Referring now to the drawings, in particular to FIG. 1A, there is shown a perspective view of the multifunctional remote control 100. The multifunctional remote control 100 permits an administrator to control and/or monitor a user's television usage and additionally provides sensory feedback to the user during use. The multifunctional remote control 100 can be a computer implemented device, but analog, digital, combinations, or variations thereof can also be implemented in accordance with the functions described herein.

As best shown in FIGS. 1A and 1B, the multifunction remote control 100 includes a substantially hollow, curvilinear body 101 enclosing the components facilitating various operations of the multifunction remote control 100. In an embodiment, the body 101 is desirably shaped as an anthropomorphic representation of a finger pressing down on an object. The body 101 includes a relatively short first or front section 102, an intermediate curved, second section 103 contiguous with the first section 102, and a substantially elongate third section 104 extending from the second section 103. The curvilinear, finger-shape is very ergonomic and comfortably conforms to the natural holding position of a user's hand. Features such as selectors 112, digital display 114, and an authentication device 118, the details of which will be further described, are desirably disposed at preselected positions on the body 101 for ease of interaction therewith by the user. In normal use, the palm of a user's hand can rest or wrap around the third section 104 leaving the fingers or thumb free to operate the selectors 112 without hindering the user's view of the display 114. It is noted that the shape of the body 101 can be any desired shape. However, the anthropomorphic shape is desired because though the shape has universal appeal, the shape has more appeal for the young and represents a more entertaining factor that invites positive interaction from children.

As shown, the multifunction remote control 100 includes one or more button interface or selectors 112, for permitting the user to control channel selection and other television capabilities, an infrared interface, or transmitter 106 for transmitting control signals to the television or television controller, an authentication device 118 for detecting the user, such as a fingerprint reader, for identifying the user, and an output unit 116 such as a digital display 114 for providing visual user input and feedback to the user, and a light panel 120 for providing sensory feedback to the user. The selectors 112 are desirably disposed on the curved second section 103 within easy reach of the user's fingers or thumb. The digital display 114 is desirably disposed on the front section 102 spaced from the second section 103 so as to provide unencumbered view of operations. The authentication device 118 is desirably disposed on a side of the housing 100 the second section 103 where the user's thumb and/or finger normally can reside during use. Further, the digital display 114 can be representative of a fingernail while the curved second section 103 can be representative of a knuckle maintaining the anthropomorphic theme of a finger.

Continuing to FIG. 1B, there is shown a sectional view of the multifunctional remote control 100, further including a power source, such as a battery 104 for providing power, a circuit board or controller 105, including a central processing unit or processor 108 for receiving and processing information from the authentication device 118 and memory 110.

As shown in FIGS. 1A and 1B, the fingerprint reader 118 can be any type of electronic device adapted to capture data, and/or capture an image of the user's fingerprint pattern. The fingerprint reader 118 can include fingerprint sensing technologies such as, for example, optical sensors, ultrasonic sensors, capacitance sensors, passive capacitance sensors, and active capacitance sensors. Other types of authentication devices 118 include, for example, biometric devices for detecting user biometric information, such as finger vein recognition, iris recognition, voice recognition, personal identification number (PIN), or a combination thereof, and is not limited in this regard.

As shown in FIG. 1B, the power source 104 can be a battery 104, or any similar device capable of providing power to the multifunctional remote control 100. The power source 104 can be coupled to a charging device, or connected to a standard outlet for electrical power. The transmitter 106 is adapted to transmit data, which can be in the form of electronic data, via infrared, wired signals, wireless signals, Bluetooth®, or a variation thereof. The information and operations that are transmitted throughout the various embodiments are desirably wireless or optics, for example, infrared transmission. However, USB connections or any of various types of hard wire connections or combinations thereof can also be used to transmit data between the multifunctional remote control 100 and the device to be controlled such as a television.

The multifunctional remote control 100 is adapted to provide sensory feedback to a user. To permit sensory feedback, the multifunctional remote 100 can be formed in a well-adapted material, such as, for example, Acrylonitrile Butadiene Styrene (ABS), or any suitable plastic or metal material. The multifunction remote control 100 can be produced using processes, such as, mechanical manufacturing, stereolithography or fused deposition modeling, for example. Notably, the multifunctional remote control 100 can include additional components and accordingly, the control 100 is not limited in this regard.

The multifunctional remote control 100, as shown in FIGS. 1A and 1B can include a unique design and additional components, but are not limited in this regard. As shown, embodiments of the multifunctional remote control 100 can provide the fingerprint reader or fingerprint recognition module 118, controller and processor 108, memory 110, and output units 116 as separate components. It is however contemplated that the aforementioned components can also be included or integrated in combination with the circuit board 105, for example. Notably, the overall size of the multifunctional remote control 100 can vary. Accordingly, the embodiment of the multifunctional remote control 100 can include a computer, tablet, PDA, smart phone or cellular phone, for example.

The multifunctional remote control 100 is programmable to provide sensory feedback that encourages the user to stay a preselected viewing distance away from the television, as well as control the viewing time available for the particular user. The multifunctional remote control 100 can include audio feedback and visual feedback to control the viewing selection accessible to the user.

During use, the multifunctional remote control 100 can include sensory feedback via the output unit 116, such as vibrations, olfaction, and voltage or electrical stimulus. Sensory feedback can also be delivered interactively through the digital display 114 or on-the screen provided by the television or digital console. The sensory feedback feature can further include visually displaying an assortment of colors and/or shapes on the light panel 120 or digital display 114. For example, the color red can indicate an attempt to view a prohibited channel, and green will indicate that a selected channel is appropriate for viewing by a child. The audio feedback of the output unit 116 can produce an audio message to the user or child indicating to “please turn down the volume” if the volume exceeds a preselected level or “you have one hour left” informing the viewer the amount of television viewing time that is available.

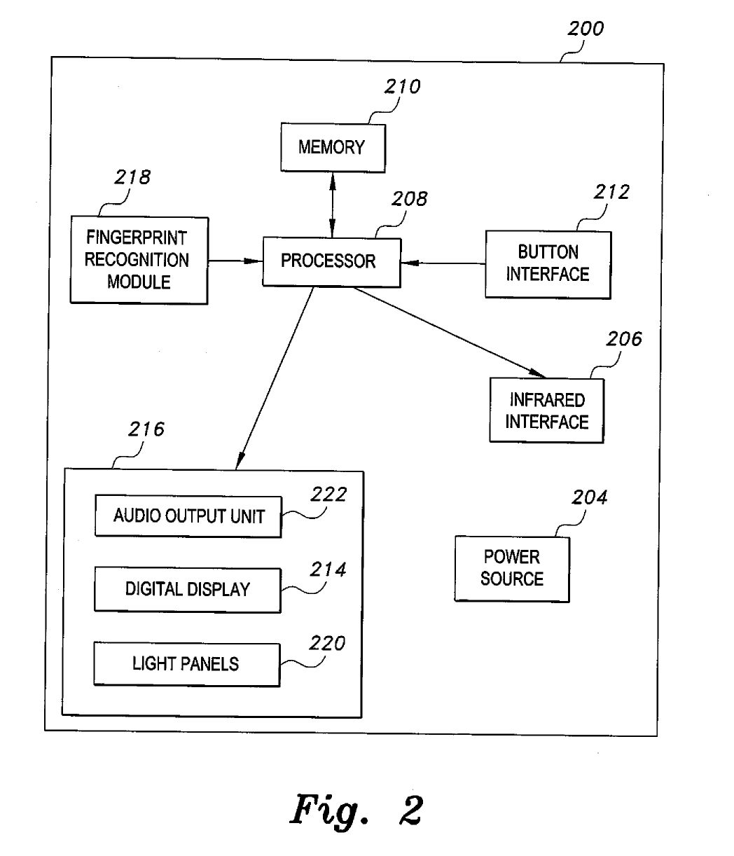

Referring now to FIG. 2, the functions disclosed utilize similar reference numerals of FIGS. 1A and 1B, however are of a 200 series, and accordingly correspond to the aforementioned components disclosed in the embodiment of FIGS. 1A and 1B. As shown in FIG. 2, the multifunctional remote control 200 can include a fingerprint recognition module or reader 218, a power source 204, such as the battery 204, an infrared interface 206, and one or more button interfaces 212. The multifunctional control 200 can further include a processor 208, memory 210 in communication with the processor 208, and an output unit 216 to provide feedback to the user. The output unit 216 can include an audio output unit 222, a digital display 214, and a light panel 220. However, notably, the output unit 216 is not limited in this regard, and can include other output devices to provide feedback, such as vibration or electric stimulus. The sensory output units 216, the processor 208, the memory 210 and any associated computer readable recoding media are in communication with one another by any suitable type of system or data bus, for example.

The fingerprint recognition module or reader 218 is adapted to detect information, such as the fingerprint data. The recognition module 218, in communication with the processor 208, sends the information to the processor 208. The general system of the multifunctional remote control 200 can also include a number of additional authentication methods after the fingerprint verification of the multifunctional remote control, such as iris recognition, voice recognition, personal identification number (PIN), another biometric or physical trait, or a combination thereof and is not limited in this regard.

The central processing unit, such as the processor 208, can be associated with, or incorporated into, any suitable type of electronic device, for example, a personal computer, portable computing device, smartphone, or a programmable logic controller. The central processing unit 208 is in communication with the button interface or selectors 212, memory 210, finger recognition module 218, and transmitting or infrared interface 206.

Data entered into the fingerprint recognition module 218 via any suitable type of interface, such as the fingerprint reader 218, can be stored in the memory 210, which can be any suitable type of computer readable and programmable memory 210 and can be a non-transitory, computer readable medium. Record data, user profiles or a number of information can also be programmed and stored in a memory, such as the memory 210, for example. Examples of computer readable memory 210 as can be used or included in the memory 210 can include a non-transitory computer readable storage memory, a magnetic recording apparatus, an optical disk, a magneto-optical disk, and/or a semiconductor memory (for example, RAM, ROM, etc.). Examples of magnetic recording apparatus that can be used in addition to or in place of the memory 210 include a hard disk device (HDD), a flexible disk (FD), a magnetic tape (MT). Examples of the optical disk include types of DVDs (Digital Versatile Discs), DVD-RAMs, CD-ROMs (Compact Disk Read Only Memory), and CD-Rs (recordable)/RW.

The digital display 214 can include a plurality of visual words, messages and/or symbols, such as, for example, check marks, music notes, alarm clocks, stop signs, “Go” signs. The light panel 220 can include a number of colors to represent sensor feedback, such as green for approval when a user selects a channel that he or she is authorized to view, red for denial of authorization, and yellow for neutral. Notably the light panel 220 is not limited in this regard and additional colors can be displayed without departing from the scope of the invention. Notably, embodiments of the multifunctional remote control and methods of operation can that the audio or written feedback can be provided various languages and is not limited in this regard. Additional embodiments include for a number of preset audio or written messages on the remote and customizable messages to be stored and recorded into the remote.

The multifunctional remote control 200 can be programmed at the multifunctional remote control 200 by the user, or through an external computer-implemented device that is in communication to the multifunctional remote control 200 Operations can be controlled at the central processing unit, such as the processor 208, which can be any suitable type of computer processor.

The processor 208 compares the detected fingerprint data to recorded fingerprint data stored in the memory 210. If the finger print data detected matches with the data recorded, the user is authorized to select television channels to view, using the button interface 212. The processor 208 receives the user's selection from the interface 212 and verifies the user has access to the selected channel, based on the assigned authorization information stored in the memory 210. If verified, the processor 208 sends a signal through the infrared interface 206 to a television or content provider, such as a cable box. In addition, the processor 208 can also send a signal to an output unit 216 to provide at least one sensory feedback to the user, such as an audio message or sound from the audio output unit 222, a picture or written message from the digital display 214, or a number of colored lights from the light panel 220. The processor 208 can also use a combination of the sensory output units 216, or other sensory output units such as vibrations, olfaction, and voltage or electrical stimulus, for example, and is not limited in this regard.

The method for operating the multifunctional remote control using fingerprint verification and providing sensory feedback can be performed by any suitable computer system, such as diagrammatically shown in the drawing of the multifunctional remote control 200 of FIG. 2.

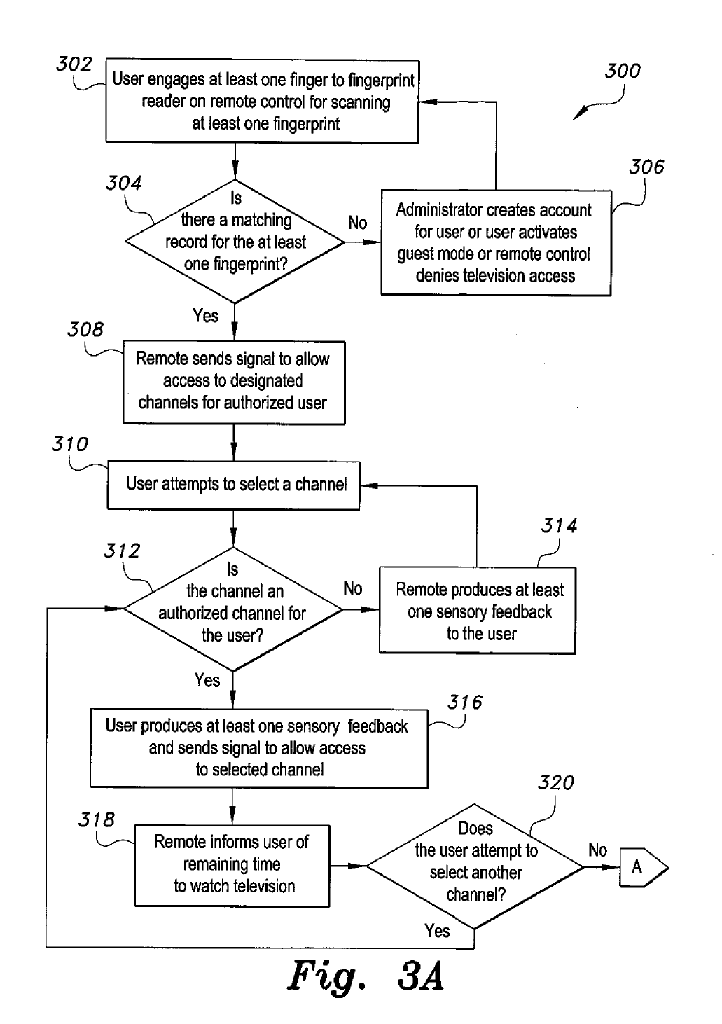

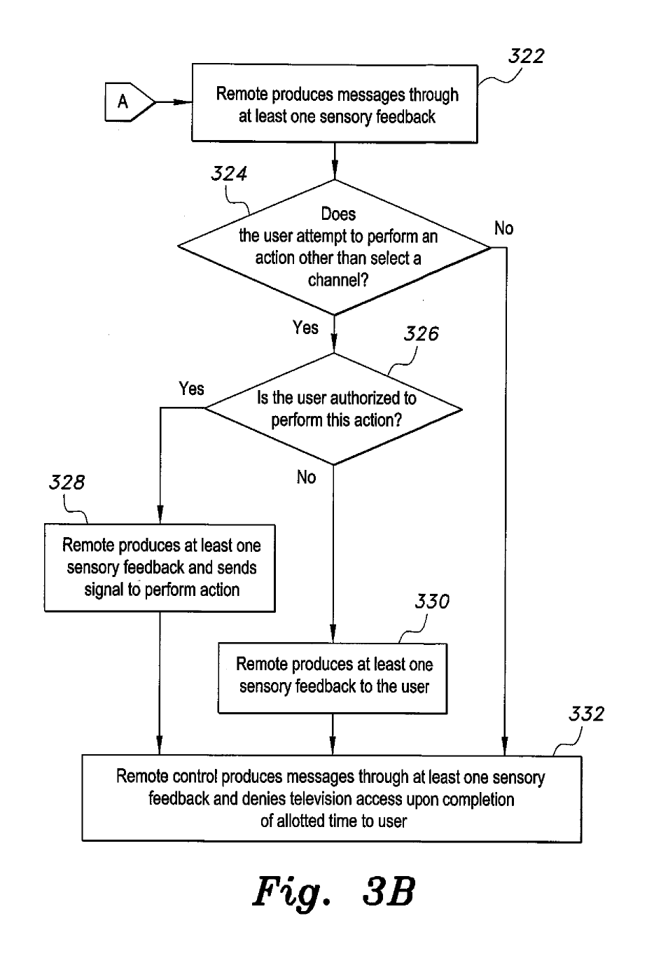

FIGS. 3A and 3B, illustrate a flowchart of a logic tree 301 of a method for operating a multifunctional remote control having fingerprint verification and sensory feedback, such as the general multifunctional remote control 200 of FIG. 2. As disclosed in the flow chart 301, at step 302 a user engages the control 200 with at least one finger to the fingerprint reader or fingerprint recognition module 218 and the fingerprint is detected by the reader.

Thereafter, step 304 provides that the multifunctional remote control 200 compares or match record data stored in the memory 210 to the fingerprint data detect of the user. If there is not a match of the fingerprint data to the record data in the memory at 303, an administrator for the multifunctional remote control 200 can create an account for the user, or the user can access the television in a guest mode, e.g. being able to view standard government channels or pre-authorized channels, at step 306. The multifunctional remote control 200 can also deny television access to the user at step 306.

If there is a match at 304, the remote control 200 sends a signal to permit the user access to a number of preselected channels for the specified user at step 308. Continuing at step 310, the user selects a channel using the multifunctional remote control 200. At step 312, the multifunctional remote control 200 compares information stored in the memory, as to whether the channel selected by the user is an authorized channel for the specific user. If the channel is not an authorized channel at step 312, the multifunctional remote control produces at least one sensory feedback to the user at step 314 and the user is prompted to select another channel at step 310.

If, at step 312, the channel selected by the user is an authorized channel for the specific user, the multifunctional remote control produces at least one sensory feedback to the user, such as a colored light from the light panel 220 or a written message from the digital display 214 of FIG. 2, and sends a signal to allow access to the selected channel at step 316. Continuing at step 318, the multifunctional remote control can inform the user of the remaining or allotted time the user has to watch television. At step 320 the multifunctional remote control can check whether the user attempts to select another channel. If the user has attempted to select another channel, the multifunctional remote control checks whether the new channel is an authorized channel for the user at step 312.

If, at step 320, the user has not attempted to select another channel, the multifunctional remote control can produce a number of messages through at least one sensory feedback at step 322, such as a reminder recorded from the child's parent, for example. The messages produced from the at least one sensory feedback at step 322 can be a variety of messages and feedback, such as an audio message encouraging a child to be good to their parents, a written reminder to the child or providing moral and religious nurturing.

Continuing at step 324, the multifunctional remote control can check whether the user has attempted to perform an action other than selecting a channel, such as changing the volume, for example. If the user does not attempt another action at step 324, the multifunctional remote control can produce at least one sensory feedback, such an audio moral message from the audio output unit 222 of FIG. 2, and end television access upon completion of the allotted time to the user at step 332.

If, at step 324, the multifunctional remote control has determined the user has attempted to perform an action, the multifunctional remote control then checks whether the user is authorized to perform the action at step 326. If the user is authorized to perform the action, the multifunctional remote control produces at least one sensory feedback and sends a signal to perform the action at step 328. Continuing from step 328, the multifunctional remote control can produce additional sensory feedback, such as displaying an image on the digital display 220 of FIG. 2, and end television access upon completion of the allotted time to the user at step 332.

If the user is not authorized to perform the action attempted at step 326, the multifunctional remote control can produce at least one sensory feedback to the user at step 330, such as displaying a stop sign on the digital display of the remote control, for example. Continuing from step 330, the multifunctional remote control can produce additional sensory feedback, such producing an audio message from a child's parent, and end television access upon completion of the allotted time to the user at step 332.

It should be noted by persons of ordinary skill in the art that equivalent replacements or variations of components or units with the same or similar property and purpose can be made in embodiments of a multifunctional remote control providing sensory feedback and, therefore, should not be construed in a limiting sense. It is to be further understood that the present invention is not limited to the embodiments described above, but encompasses any and all embodiments within the scope of the following claims.

1. A multifunctional television remote control device, comprising:
a housing for handling by a user, the housing having a first section, a third section and a second section intermediate to the first section and third section, wherein the first, second and third sections are configured in an anthropomorphic shape;
at least one authentication device to detect at least one user biometric feature and obtain user biometric data, the at least one authentication device coupled to the housing;
a memory to store user feature information for at least one user, the memory being in operative communication with the at least one authentication device, each stored user feature information having pre-assigned viewing content and allotment of time for viewing for each user;
at least one output unit coupled to the housing, the at least one output unit providing sensory feedback to the user within the housing,
a processor to compare user feature information stored in the memory to the detected user biometric data and permit preselected viewing content to be stored to memory, the processor being in operative communication with the at least one authentication device and memory; and
wherein the processor compares the detected biometric feature to user feature information stored in the memory and upon finding a match, permits the user to control selection of viewing content pre-assigned to the user.

2. The multifunctional remote control device according to claim 1, wherein the at least one authentication device comprises a fingerprint detection module to detect the fingerprint of the user, the fingerprint of the user corresponding to the user biometric data.

3. The multifunctional remote control device according to claim 2, wherein the finger detection module is disposed on a side portion of the second section of the housing.

4. The multifunctional remote control device according to claim 1, further comprising at least one selector, the at least one selector being disposed on the second section of the housing.

5. (canceled)

6. The multifunctional remote control device according to claim 1, wherein the at least one output unit comprises at least one digital display provided on the first section of the housing.

7. The multifunctional remote control device according to claim 1, wherein the at least one output unit comprises at least one light panel provided on the second section of the housing.

8-19. (canceled)
